(19) United States
(12) Patent Application Publication
(10) Pub. No.: US 2004/0064308 A1
(43) Pub. Date: Apr. 1, 2004

(54) Method and apparatus for speech packet loss recovery

(75) Inventor: Michael E. Deisher, Hillsboro, OR (US)

Correspondence Address: Pillsbury Winthrop LLP, Intellectual Property Group, Suite 2800, 725 South Figueroa Street, Los Angeles, CA, 90017-5406, US

(73) Assignee: Intel Corporation, Santa Clara, CA (US)

(21) Appl. No.: 10/261,616

(22) Filed: Sep. 30, 2002

(51) Int. Cl. G10L 19/14

(52) U.S. Cl. 704/211

(57) ABSTRACT

A system includes a frame reception device to receive a stream of frames. An energy determination device determines a first energy of a first frame preceding a gap, and a second energy of a second frame, and the second frame is received after the first frame. A candidate testing and blending device determines at least one of first portion of the first frame and a second portion of the second frame to insert in place of the gap, based on the first energy trajectory and the second energy trajectory, and on a determination of an optimal blend point, and blends with at least one of the first frame and the second frame.

### BACKGROUND

1. Technical Field

An embodiment of the invention relates to the field of packet reception, and more specifically, to a system, method, and apparatus to determine when frames of data transmitted in a stream of packets are missing, and determine replacement frames for the missing frames.

2. Description of the Related Arts

Speech data is often transmitted via frames of data in packets. Each packet often contains multiple frames of speech data. There are systems in the art that transmit/receive such packets for Internet Protocol telephony (e.g., International Telecommunication Union Recommendation H.323, Packet-Based Multimedia Communications Systems, November 2000) or for cellular telephone applications. Because speed is an important concern, such packets are often transmitted/received via a protocol which does not guarantee delivery. Accordingly, packets containing frames of data are sometimes not received after they have been transmitted, due to network congestion, interference, or other common errors or disruptions.

When streamed packets are received, and the frames are extracted therefrom, a reception device must then reconstruct the transmitted digital speech signal. Each of the frames contain a portion of the speech signal or representation thereof. When a packet, and the frames contained therein, is not properly received, current systems have differing methods of reconstructing the speech signal. Some systems simply insert silence, or a “NULL” signal in the place of missing frames. However, the insertion of silence can make the reconstructed signal sound choppy and unusual to a person listening to an acoustic representation of the received signal.

Other systems simply copy the frame before the missing frame, and insert the copy in the place of the missing frame However, such a reconstructed sound signal often sounds unnatural and buzzy. Additional systems copy a portion of the frame before the missing frame and a portion of a frame after the missing frame and insert it into the place of the missing frame. However, such systems simply insert equal portions of the previous frame and of the subsequent frame in the place of the missing frame. This can result in distortion and an unnatural sound if such equal portions of the previous frame and the subsequent frames have differing energy levels.

### BRIEF DESCRIPTION OF THE DRAWINGS

FIG. 1 illustrates a packet encoding device according to an embodiment of the invention;

FIG. 2 illustrates a packet reception device according to an embodiment of the invention;

FIG. 3 illustrates a frame reconstruction device according to an embodiment of the invention;

FIG. 4A illustrates an example of a “flat” energy signal according to an embodiment of the invention;

FIG. 4B illustrates an example of a “hump” energy signal according to an embodiment of the invention;

FIG. 4C illustrates an example of a “valley” energy signal according to an embodiment of the invention;

FIG. 4D illustrates an example of a “rising” energy signal according to an embodiment of the invention;

FIG. 4E illustrates an example of a “falling” energy signal according to an embodiment of the invention;

FIG. 5A illustrates a gap located between a previous frame and the next frame of a sequence of frames according to an embodiment of the invention;

FIG. 5B illustrates portions X₀, X₀ₐ, and X_{0b} of previous frame according to an embodiment of the invention;

FIG. 5C illustrates portions X₂, X₂ₐ, and X₂ₕ of next frame according to an embodiment of the invention;

FIGS. 6A-1 to 6A-3 illustrate portion X_{0b} being compared with a copy of portion X_{0b} on a sample-by-sample basis according to an embodiment of the invention;

FIG. 6B illustrates a blend testing portion in which to test for the best blend point between portion X_{0b} and the copy of portion X_{0b} according to an embodiment of the invention;

FIG. 6C illustrates portion X_{0b} and the copy of portion X_{0b} after application of a blending function according to an embodiment of the invention;

FIG. 6D illustrates a reconstruction portion formed by the blending of portion X_{0b} with the copy of portion X_{0b} according to an embodiment of the invention;

FIG. 6E illustrates an extended reconstructed portion formed from the reconstructed portion and a periodic extension according to an embodiment of the invention;

FIG. 7 illustrates a method to form reconstructed data according to an embodiment of the invention;

FIG. 8 illustrates a method to sample and encode frames into packet, transmit them across a network, and reconstruct them into an audio signal according to an embodiment of the invention;

FIG. 9 illustrates a method to reconstruct missing frames according to an embodiment of the invention;

FIG. 10 illustrates an enlarged view of the candidate section determination device according to an embodiment of the invention; and

FIG. 11 illustrates an enlarged view of the blending device according to an embodiment of the invention.

### DETAILED DESCRIPTION

An embodiment of the present invention may be utilized to receive a stream of packets, each of the packets having at least one frame of data. Each of the frames of data may contain a 10-30 millisecond block of digital samples of audio data or representation thereof. When the stream is transmitted/received via a protocol which does not guarantee delivery, such as User Datagram Protocol (UDP) (Internet Engineering Task Force, Request for Comments 768, User Datagram Protocol, Aug. 28, 1980), sometimes packets in the stream are not properly received. Accordingly, in such situations, the frames of data in the packets which are not properly received cannot be used to reconstruct an audio signal from the received packets. An embodiment of the invention may arrange the frames of data in sequential order, and may then determine which frames of data are missing, and may reconstruct such frames from other frames that were transmitted in properly received packets. Based on the signal energy trajectory of a frame prior to the missing frame(s), and on the energy trajectory of a frame subsequent to the missing frame(s), the system may copy (a) a portion of the frame prior to the missing frame(s), (b) a portion of the frame subsequent to the missing frame(s), (c) portions of both such frames, or (d) replicated copies of (a), (b), or (c), and insert in place of the missing frame(s). A blending function may be used to determine an appropriate location at which to “blend” or mesh the copied portions of the frames to ensure a more natural sounding reconstructed frame.

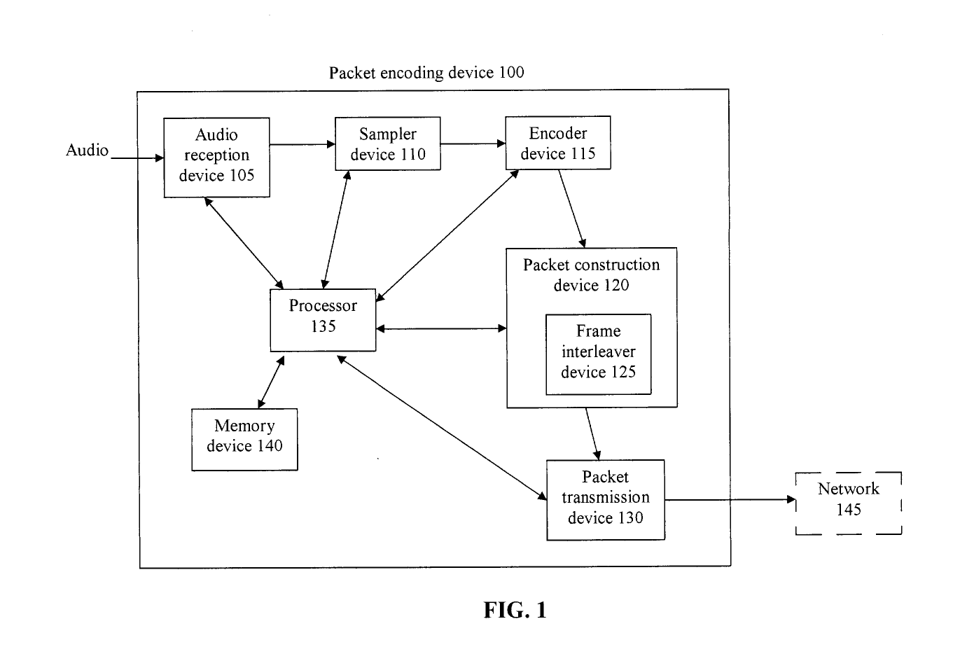

FIG. 1 illustrates a packet encoding device 100 according to an embodiment of the invention. An audio signal may be received by an audio reception device 105. The audio reception device 105 may convert and transmit an analog version of the audio signal to a sampler device 110. The sampler device 110 may convert the analog audio signal into a digital signal. The sampler device 110 may sample the analog audio signal at an appropriate sample rate, such as 8 Kilo-bits/second (Kbps). The appropriate sample rate may be a function of the speed of a processor 135 controlling the sampler device 110, for example. The sampler device 110 may then output a digital audio signal to an encoder device 115. The encoder device 115 may be a waveform encoder, and have a function of converting the digital audio signal into a compressed digital waveform.

The encoder device 115 may then output the digital waveform to a packet construction device 120. The packet construction device 120 may be utilized to form packets of frames of the digital samples in the digital waveform. Each of the frames of audio data may contain 10-30 milliseconds of audio samples, for example. Since the frames contain such a small amount of audio data, an embodiment of the invention may include multiple frames in each packet. If the packets are sent via a protocol that does not guarantee delivery, such as UDP, then a packet that is missing or not properly received can result in multiple missing frames. Accordingly, to minimize the chances that consecutive frames are missing, the packet construction device 120 may include a frame interleaver device 125, which interleaves frames into each of the packets. In other words, rather than including multiple consecutive frames in each of the packets, the frames may instead be “interleaved” and therefore a frame may be contained in a different packet than the frame before it or after it. For example, all odd numbered frames in a series of sequential frames may be contained in a first packet, and all even numbered frames in the series may be contained in a second packet. Accordingly, if only the first frame is received, at most one consecutive frame would be missing. The packet construction device 120 may output constructed packets to a packet transmission device 130, which may then transmit an encoded packet across a network 145.

In an embodiment, each of the audio reception device 105, the sampler device 110, the encoder device 115, the packet construction device 120, and the packet transmission device 130 may be controlled by a processor 135. The processor 135 may be in communication with a memory device 140. The memory device 140 may contain program-executable instructions which may be executed by the processor 135, for example. In other embodiments, some, or all of, the audio reception device 105, the sampler device 110, the encoder device 115, the packet construction device 120, and the packet transmission device 130 may contain their own processor devices.

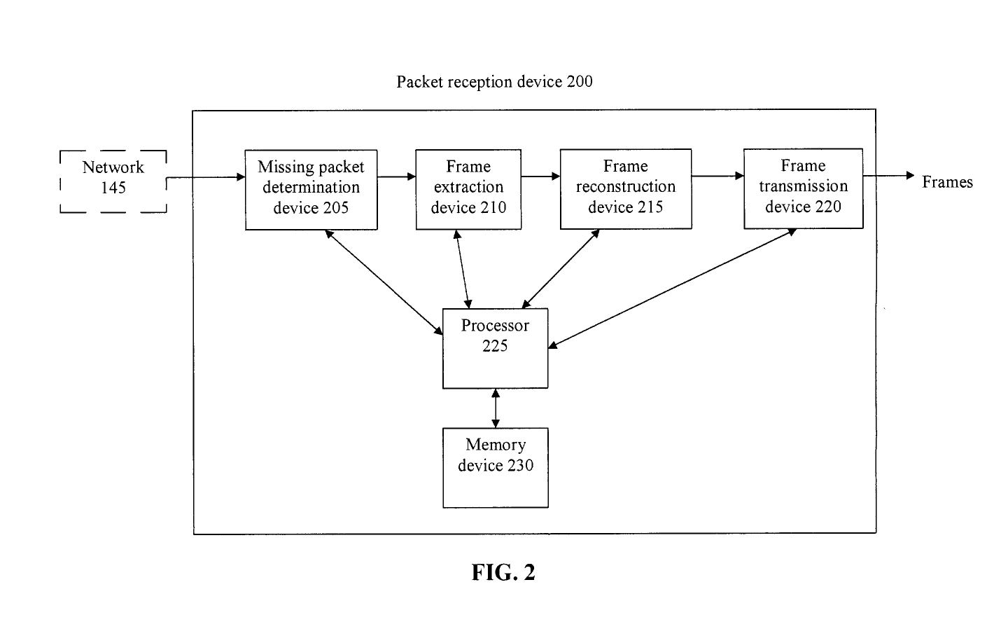

FIG. 2 illustrates a packet reception device 200 according to an embodiment of the invention. In an embodiment, the packet reception device 200 may be contained within a router, for example. The network 145 may supply packets to a missing packet determination device 205 of the packet reception device 200. The missing packet determination device 205 may be utilized to determine whether a packet in a stream of packets is not properly received. For example, in an embodiment where a stream of packets is sent to a cellular telephone, a packet might not be properly received due to electromagnetic interference, network congestion, a transmission error, or any number of other causes.

When a packet is not received properly, or “missing”, the packet reception device 200 may then determine which frames were contained in the packet, based upon the frames contained within other properly received packets. After reception, the packet may then be sent to a frame extraction device 210. The frame extraction device 210 may have a function of removing the frames from each of the packets, and then placing the frames in sequential order. As noted above, when the analog audio signal is initially sampled by the sampler device 110 of the packet encoding device 100, the samples may be encoded into a series of sequential frames which, in turn, are interleaved within the packets.

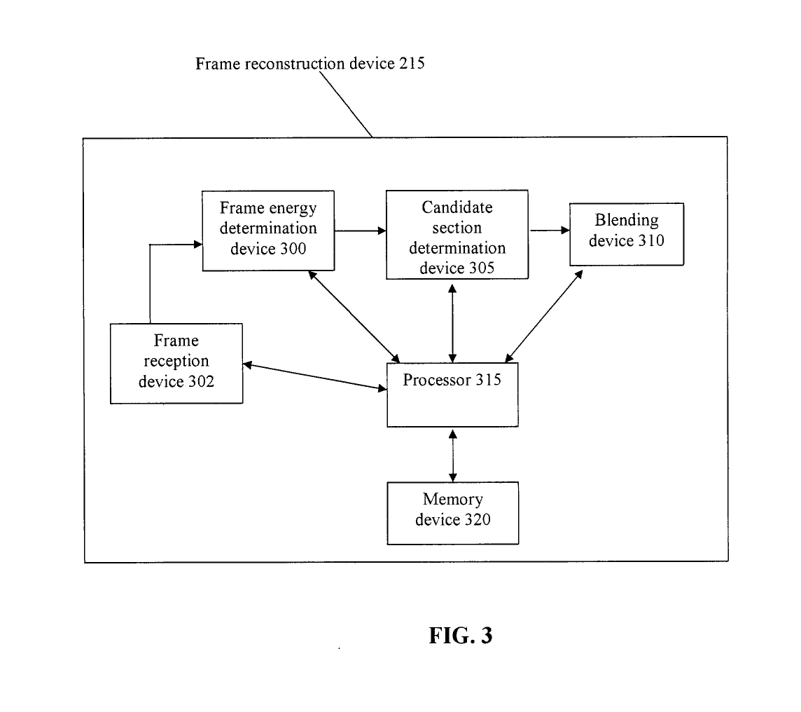

Once the packets have been received by the packet reception device 200 and the frames have been extracted by the frame extraction device 210 and placed in sequential order, the system may then insert data in the place of missing frames. A frame reconstruction device 215 may have a function of determining what data should be inserted in place of the missing frames, based upon the energy trajectory of the frames before and after a missing frame, as explained below with respect to FIG. 3.

After data has been inserted in place of the missing frames, the sequential frames are sent to a frame transmission device 220. The frame transmission device 220 may then send the frames to a device which may reproduce an audible audio signal based on the frames. For example, the frames may be transmitted to a digital-to-analog (D/A) converter, which may be coupled to a speaker. The D/A converter and speaker may be coupled to a personal computer (PC) to allow a user to listen to streaming audio data such as a PC-based telephone call or Internet radio. Alternatively, the D/A converter and speaker may be housed within a cellular telephone to allow the user to listen to another user via a cellular network.

The missing packet determination device 205, the frame extraction device 210, the frame reconstruction device 215, and the frame transmission device 220 may all be coupled to a processor 225 of the packet reception device 200. The processor 225 may be in communication with a memory device 230. The memory device 230 may contain program-executable instructions which may be executed by the processor 225, for example. In other embodiments, some, or all of, the missing packet determination device 205, the frame extraction device 210, the frame reconstruction device 215, and the frame transmission device 220 may contain their own processor devices.

FIG. 3 illustrates a frame reconstruction device 215 according to an embodiment of the invention. The frame reconstruction device 215 may be utilized to determine data to insert in the place of a missing frame. The frame reconstruction device 215 may be utilized to determine which audio data provides the “best” fit in the place of the missing audio data. A chief concern is to insert audio data which provides the most natural sound, so that when the audio data is inserted in the place of a missing frame, a sound signal reproduced from the sequential frames sounds most natural. Ideally, a listener of the reproduced sound signal would not be able to tell that reconstructed frames have been inserted in the place of missing frames of data.

The frame reconstruction device 215 may determine what audio data to insert in place of a missing frame based on the energy characteristics of the frame immediately before and the frame immediately after the missing frame. The frame reconstruction device 215 may include a frame reception device 302 to receive a stream of frames, and a frame energy determination device 300 to characterize the energy trajectory of a frame. The frame energy determination device may characterize the energy trajectory of a frame as “falling” (i.e., the energy level at the end of the frame is lower than that at the start of the frame), “rising” (i.e., the energy level at the end of the frame is higher than that at the start of the frame), “flat” (i.e., the energy level at the end of the frame is substantially the same at the start, in the middle, and at the end of the frame, “valley” (i.e., the energy level in the middle of the frame is lower than the energy levels and the start and at the end thereof), or “hump” (i.e., the energy level in the middle of the frame is higher than the energy levels and the start and at the end thereof).

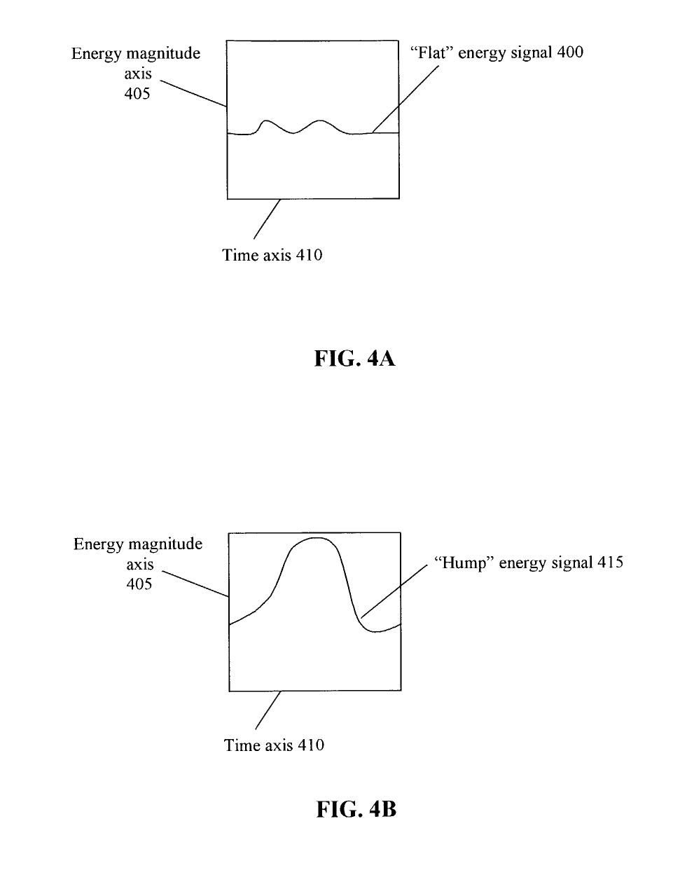

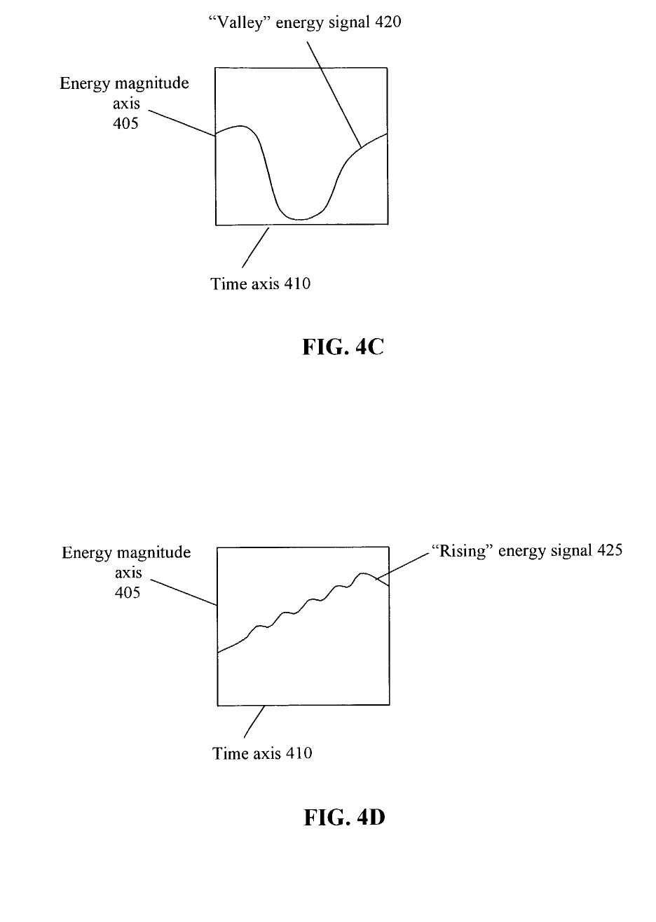

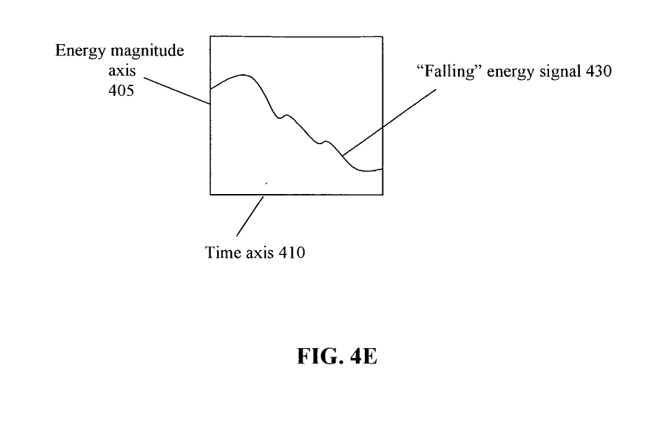

FIG. 4A illustrates an example of a “flat” energy frame 400 according to an embodiment of the invention. As shown, the vertical axis corresponds to the “energy magnitude” axis 405, and is utilized to represent energy levels of the energy trajectory of the frame. The horizontal axis represents time, and is known as the time axis 410. Accordingly, the energy magnitude axis 405 represents a magnitude of the energy of a frame over time. As shown, the flat energy signal 400 has a relatively constant energy level during the period shown on the time axis. Accordingly, an energy signal may be classified as “flat” even though the energy values at the start, middle, and end of the energy signal are not necessarily constant, provided that are within a predetermined range limit (e.g., 10% of each other).

The energy may also be computed as a discrete function of time. Specifically, an energy value may be calculated for each non-overlapping ¼ of each frame.

FIG. 4B illustrates an example of a “hump” energy frame 415 according to an embodiment of the invention. As illustrated, the hump energy frame 415 has energy levels at its start and end points that are close in magnitude, and the energy level in the middle of the frame is higher than that of the start and the end.

FIG. 4C illustrates an example of a “valley” energy frame 420 according to an embodiment of the invention. As illustrated, the valley energy frame 420 has energy levels at its start and end points that are close in magnitude, and the energy level in the middle of the frame is lower than that of the start and the end.

FIG. 4D illustrates an example of a “rising” energy frame 425 according to an embodiment of the invention. As illustrated, the rising energy frame 425 has an energy level at its end point that has a larger magnitude than that of the middle. Also, the energy level in the middle is higher than that of the starting point.

FIG. 4E illustrates an example of a “falling” energy frame 430 according to an embodiment of the invention. As illustrated, the falling energy frame 430 has an energy level at its end point that has a smaller magnitude than that of the middle. Also, the energy level in the middle is lower than that of the starting point.

Through testing, it has been determined that a natural-sounding replacement for a missing frame can be determined based on the energy characteristics (e.g., whether the energy of the frame is “flat,” “hump,” “valley,” “rising,” or “falling”) of the frame immediately before and of the frame immediately after the missing frame in the sequence of frames.

Table 1 below is a table containing the settings for frame reconstruction. The “Previous” column refers to the frame before a missing frame which is to be filled with best-fitting audio data. The “Next” column refers to the frame after the missing frame. Located in the “Previous” and “Next” columns are the different energy trajectory scenarios (e.g., “falling,” “rising,” “flat,” “hump,” and “valley”). The “No. of samples to extend forward” column contains values which indicate on average how much of the frame prior to the missing frame should be included into a reconstructed frame to insert in the place of the missing frame. “N” indicates the frame size, e.g., the number of samples in each frame. For reconstruction of missing data, the system may utilize the same frame size (“N”) for all frames. In other embodiments, such as those for use with speech Coder-Decoders (codecs) which use variable frame size, samples may be regrouped into frames of size “N” before processing by the frame reconstruction device 215. Codecs for use with additional embodiments may process data sample-by-sample instead of using frames. For such sample-by-sample codecs, the samples may be grouped into frames for the purposes of reconstruction before processing by the frame reconstruction device 215.

“K” of Table 1 represents the “gap size,” or the size of the missing frame or frames. If only a single frame is missing, “K” may be equal to “N.” In other embodiments, “K” may be a multiple of “N.” In an embodiment where all frames have “N” samples, if multiple consecutive frames are missing, “K” may be a multiple of “N.” However, “K” need not be a multiple of “N.”

The “No. of samples to extend forward” column contains values which indicate the number of samples from the frame before the missing frame that should be used to form a periodic extension of the previous frame forward in time to replace the missing samples. The “No. of samples to extend backward” column contains values which indicate the number of samples from the frame subsequent to the missing frame that should be used to form a periodic extension of the subsequent frame backward in time to replace the missing samples. The “No. of samples to fill left” column contains values of the number of samples necessary to insert in place of the right side of the missing frame (i.e., in the leftward direction from the end of the gap). The “No. of samples to fill right” column contains values of the number of samples necessary to insert in place of the left side of the missing frame (i.e., in the rightward direction from the beginning of the gap).

The energy signals shown in FIGS. 4A-4E may be determined on a frame-by-frame basis by the frame energy determination device 300. Table 1 below have been determined to be the values that may result in a natural-sounding reconstructed frame to be inserted in place of a missing frame.

TABLE 1
Frame reconstruction settings

| | | No. of | | | |
|---|---|---|---|---|---|
| | | samples | No. of samples | No. of | No. of |
| | | to extend | to extend | samples to | samples to |
| Previous | Next | forward | backward | fill left | fill right |
| Falling | Falling | N/2 | N/2 | K | K |
| Falling | Rising | N/2 | N/2 | K | K |
| Falling | Flat | 0 | N | 0 | K + N/4 |
| Falling | Valley | N/2 | 0 | K + N/4 | 0 |
| Falling | Hump | N/2 | 0 | K + N/4 | 0 |
| Rising | Falling | N/2 | N/2 | K | K |
| Rising | Rising | N/2 | N/2 | K | K |
| Rising | Flat | 0 | N | 0 | K + N/4 |
| Rising | Valley | N/2 | 0 | K + N/4 | 0 |
| Rising | Hump | N/2 | 0 | K + N/4 | 0 |
| Flat | Falling | N | 0 | K + N/4 | 0 |
| Flat | Rising | N | 0 | K + N/4 | 0 |
| Flat | Flat | N | N | K | K |
| Flat | Valley | N | 0 | K + N/4 | 0 |
| Flat | Hump | N | 0 | K + N/4 | 0 |
| Hump | Falling | 0 | N/2 | 0 | K + N/4 |
| Hump | Rising | 0 | N/2 | 0 | K + N/4 |
| Hump | Flat | 0 | N | 0 | K + N/4 |
| Hump | Valley | N | N | K | K |
| Hump | Hump | N | N | K | K |
| Valley | Falling | 0 | N/2 | 0 | K + N/4 |
| Valley | Rising | 0 | N/2 | 0 | K + N/4 |
| Valley | Flat | 0 | N | 0 | K + N/4 |
| Valley | Valley | N | N | K | K |
| Valley | Hump | N | N | K | K |

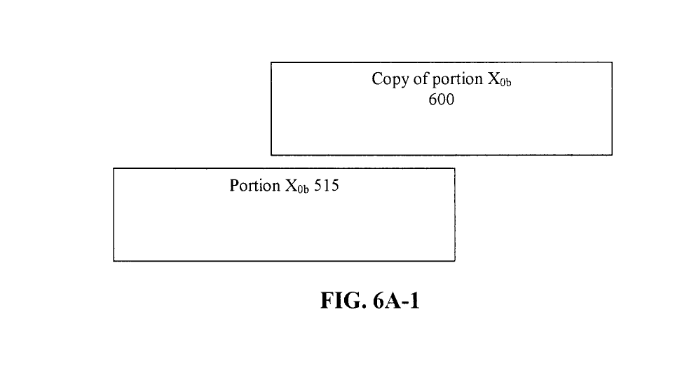

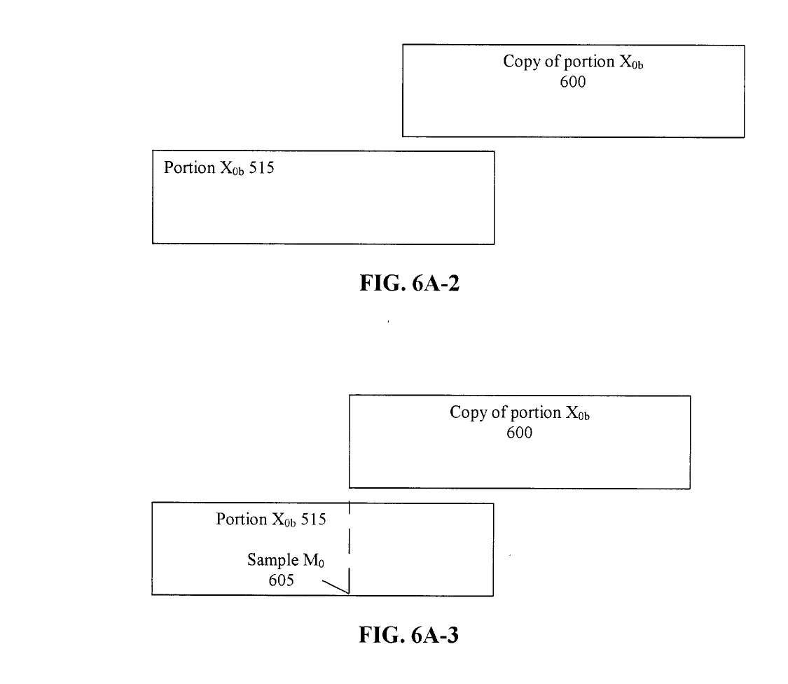

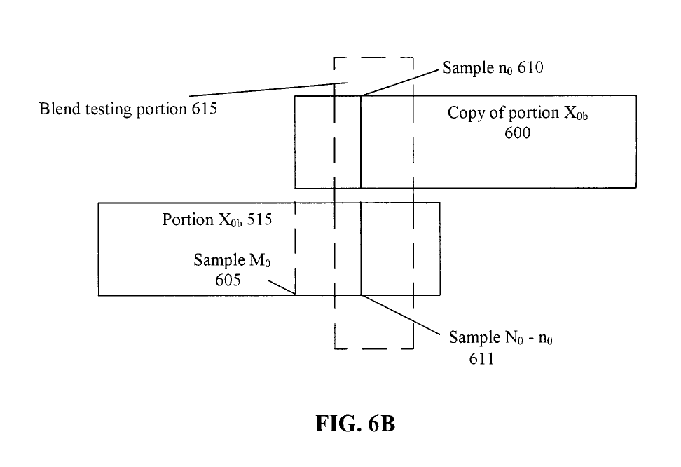

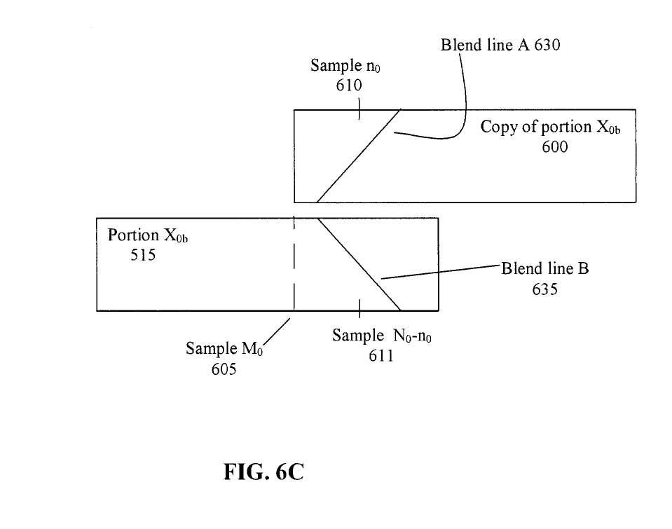

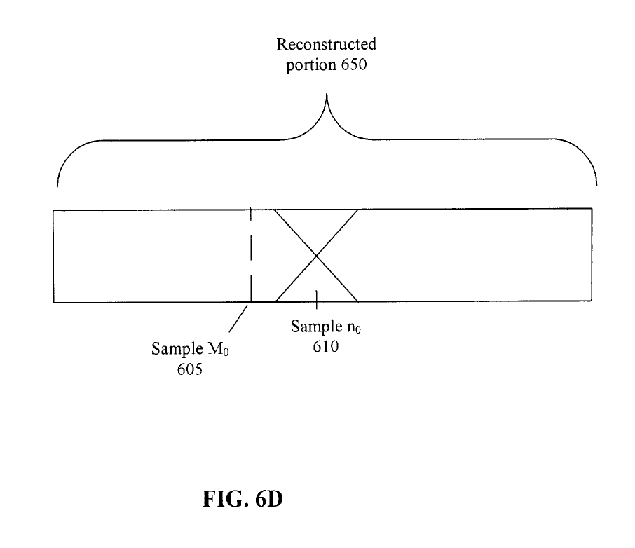

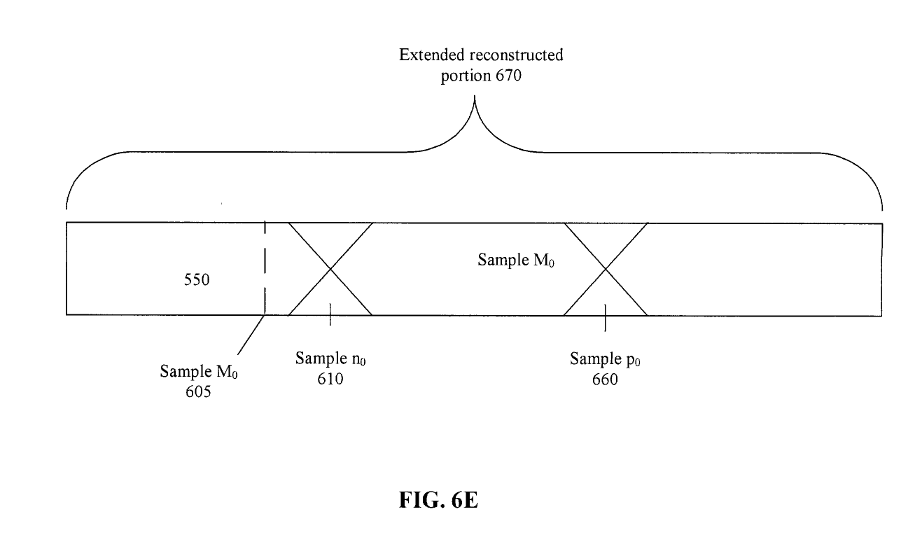

Referring to FIG. 3, the frame energy determination device outputs a calculation of the energy trajectory of a frame to the candidate section determination device 305. The candidate section determination device 305 has a function of determining candidate sections of frames that are received to insert in place of the missing portion. For example, as indicated in the chart above, if the previous frame is “falling” and the next frame after a missing portion is “falling”, then the candidate section determination device may determine that the final N/2 samples of the previous frame should be used to construct a waveform that may be extended periodically forward in place of the left hand side of the missing portion. The candidate section determination device may also determine that the first N/2 samples of the next frame should be used to construct a waveform that may be extended periodically backward in place of the right hand side of the missing portion. Once the samples have been selected to be inserted in place of the missing portion, they are blended together in order to ensure a smooth flow so that the resulting audio sounds natural. The periodic extension of the left-hand side may be blended with the left-hand side by a blending device 310. Likewise, the periodic extension of the right-hand side may be blended with the left hand side by a blending device 310. Finally, the left-hand side of missing portion and the right hand side of the missing portion are blended together by a blending device 310. As indicated in Table 1 above, K samples are needed to fill to the left and K samples are needed to fill to the right side of the missing portion. The blending of the samples performed by the blending device is described below with respect to FIGS. 6C-6E. In some embodiments, the blending device 310 may be contained within the candidate section determination device 305

In an embodiment, each of the frame energy determination device 300, the candidate section determination device 305, and the blending device 310 may be controlled by a processor 315. The processor 315 may be in communication with a third memory device 320. The memory device 320 may contain program-executable instructions which may be executed by the processor 315, for example. In other embodiments, some, or all of, the frame energy determination device 300, the candidate section determination device 305, and the blending device 310 may contain their own processor devices.

The blending device 310 may determine the best place to start the blending of the candidate piece with the frame from which it is copied by overlaping the candidate piece with the frame and determining a sum-squared error between the candidate piece and the overlapping portion of the frame. The optimal blending point may be the point at which the sum-squared error is minimized.

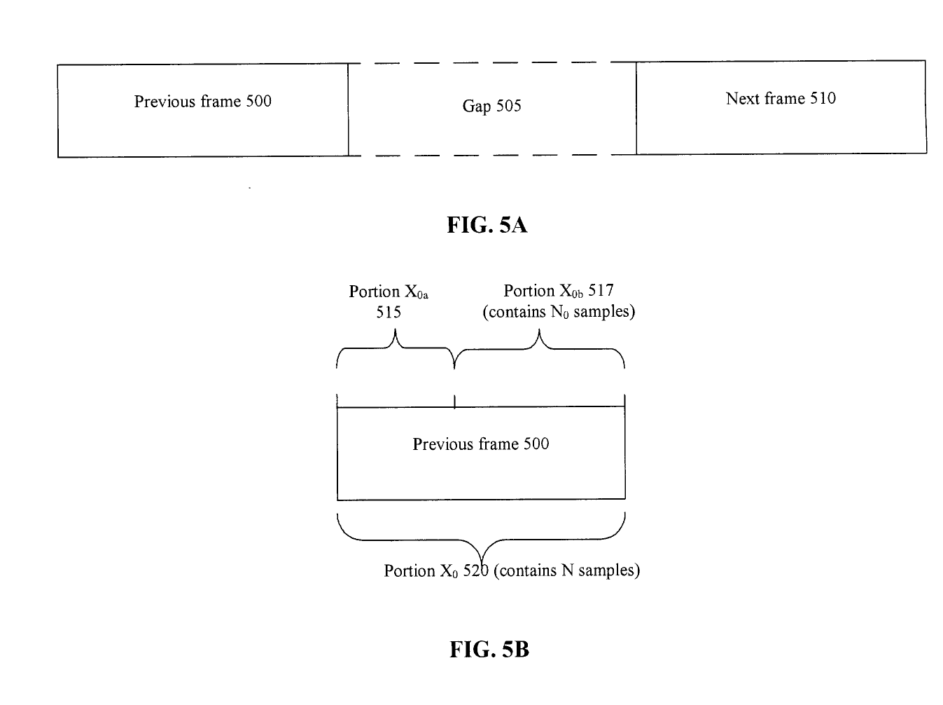

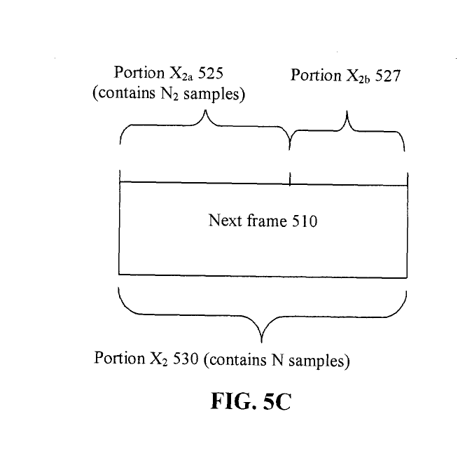

FIG. 5A illustrates a gap 505 located between a previous frame 500 and the next frame 510 of a sequence of frames according to an embodiment of the invention. In the event that this sequence of frames is sent to the frame reconstruction device 215, the frame reconstruction device 215 may determine, based on the data in the previous frame 500 and the next frame 510, what data to insert in place of the gap 505.

In the event that the candidate selection device 305 determines that the missing frame should be inserted with data from half of the previous frame 500 and from half of the next frame 510, the blending device 310 may then determine which point is the most appropriate point at which to blend the selected candidate piece. In other words, the blending device 310 may seek to a) blend previous frame 500 with a copy of the last half of the previous frame 500, b) blend next frame 510 with a copy of the first half of the next frame 510, and c) blend the extended portions with one another.

FIG. 5B illustrates portions X₀ 520, X₀ₐ 515, and X_{0b} 517 of previous frame 500 according to an embodiment of the invention. As shown, portion X_{0b} 517 may include No samples from the right-hand side of previous frame 500, and portion X₀ 520 may comprise the entire previous frame 500 and include N samples. Portion X₀ 520 may be comprised of portions X₀ₐ 515 and X_{0b} 517.

FIG. 5C illustrates portions X₂ 530, X₂ₐ 525, and X_{2b} 527 of next frame 510 according to an embodiment of the invention. As shown, portion X₂ₐ 525 may include N₂ samples from the left-hand side of next frame 510, and portion X₂ 530 may comprise the entire next frame 510 and include N samples. Portion X₂ 530 may be comprised of portions X₂ₐ 525 and X_{2b} 527.

FIGS. 6A-1 to 6A-3 illustrate portion X_{0b} 515 being compared with a copy 600 of portion X_{0b} on a sample-by-sample basis according to an embodiment of the invention. As shown in FIGS. 6A-1, part of portion X0b 515 overlaps with the copy 600 of portion X0b 515. The overlapping samples are compared with each other to determine the best sample point at which to align the copy 600 of portion X_{0b} with portion X_{0b} itself. A normalized cross-correlation may be calculated between the overlapping samples. The best alignment location may be the alignment that results in the highest normalized cross-correlation value.

After a normalized cross-correlation has been calculated, the copy 600 of portion X_{0b} 515 may be shifted 1 or more samples, and the normalized cross-correlation may again be calculated. The process may be repeated over a predetermine range of samples to determine the best alignment point. As shown in FIGS. 6A-2, the copy 600 of X_{0b} 515 has been shifted in a rightward direction relative to where it was in FIGS. 6A-1, resulting in a different overlap than that in FIGS. 6A-1.

FIGS. 6A-3 illustrates the alignment resulting in the largest normalized cross-correlation. As shown, the best alignment location is at sample M₀ 605.

FIG. 6B illustrates a blend testing portion 615 in which to test for the best blend point between portion X_{0b} 515 and the copy 600 of portion X_{0b} 515 according to an embodiment of the invention. The blend testing portion 615 may be utilized to determine the blend point resulting in the smallest sum-squared error between the samples of portion X_{0b} 515 and the copy 600 of X_{0b} 515, within the blend testing portion 615. In an embodiment, sample n₀ 610 may be the best blend point at which to blend the copy 600 of portion X_{0b} 515 with portion X_{0b} 515. Sample no 620 of the copy of portion X_{0b} 515 may be blended with sample N₀-n₀ 611 of portion X_{0b}. The blend testing portion 615 may contain “L” overlapping samples, for example.

FIG. 6C illustrates portion X_{0b} 515 and the copy 600 of portion X₀515 after application of a blending function according to an embodiment of the invention. A blending function may be applied to portion X_{0b} 515 and the copy 600 of portion X_{0b} 515 so that they can be summed to create the blended frame portions. As shown, the copy 600 of X_{0b} 515 includes blend line A 630. Blend line A 630 indicates which data is discarded, and which is kept. Samples to the right of the top of blend line A 630 are kept, and samples to the left of blend line A 630 are discarded. The samples located in the range between the bottom of blend line A 630 and the top of blend line A 630 are kept, but are multiplied by a blending factor. For example, the blending factor may be close to “1” for samples intersected by the top of blend line A 630, and close to “0” for samples intersected by the bottom of blend line A 630. The blending factor may be “0.5” for sample no 610.

A blending factor may be determined for portion X_{0b} 515. Blend line B 635 may indicate which data is discarded, and which is kept. Samples to the left of the top of blend line B 635 are kept, and samples to the right of blend line B 635 are discarded. The samples located in the range between the top of blend line B 635 and the bottom of blend line B 635 are kept, but are multiplied by a blending factor. For example, the blending factor may be close to “1” for samples intersected near the top of blend line B 635, and close to “0” for samples intersected near the bottom of blend line B 635. The blending factor may be “0.5” for sample N₀-n₀ 611.

FIG. 6D illustrates a reconstruction portion 650 formed by the blending of portion X_{0b} 515 with the copy 600 of portion X_{0b} according to an embodiment of the invention. The reconstruction portion 650 may be created by summing the non-discarded portions of portion X_{0b} 515 the copy 600 of portion X_{0b} 515 as discussed above with respect to FIG. 6C. Blend lines A 630 and B 635 have been drawn to show the location of the blending.

FIG. 6E illustrates an extended reconstructed portion 670 formed from the reconstructed portion 650 and a periodic extension according to an embodiment of the invention. For example, if the gap 505 is larger than the reconstructed portion 650, the blended portion of the reconstructed portion 650 may be extended to fill in the gap 505 because the samples on the far right side of the copy 600 of portion X_{0b} 515 are identical to the samples on the far right side of portion X_{0b} 515, the samples on the far right side of the reconstructed portion 650 are also the same as those on the right far right side of the portion X_{0b} 515. Accordingly, after the copy 600 of portion X_{0b} 515 has been blended with portion X_{0b} 515 to form reconstructed portion 650, additional copies 600 may be blended with reconstructed portion 650 to create the extended reconstructed portion 670. Since the samples on the far right side of the reconstructed portion 650 are the same as those on the far right of the copy 600 of portion X_{0b} 515, the best alignment point and the best blend point need not be recalculated. Sample p₀ 660 may be the blend point for blending an additional copy 600 of portion X_{0b} 515 with the reconstructed portion 650.

The blending process described above with respect to FIGS. 6A-1 through 6E may be repeated to reconstruct a portion to fill in the gap 505, from the next frame 510. Once a reconstructed portion 650 or an extended reconstructed portion 670 has been calculated based on the previous frame 500 and the next frame 510, the respective reconstructed portions 650 and/or extended reconstructed portions 670 may then be blended with each other to result in a natural-sounding audio data.

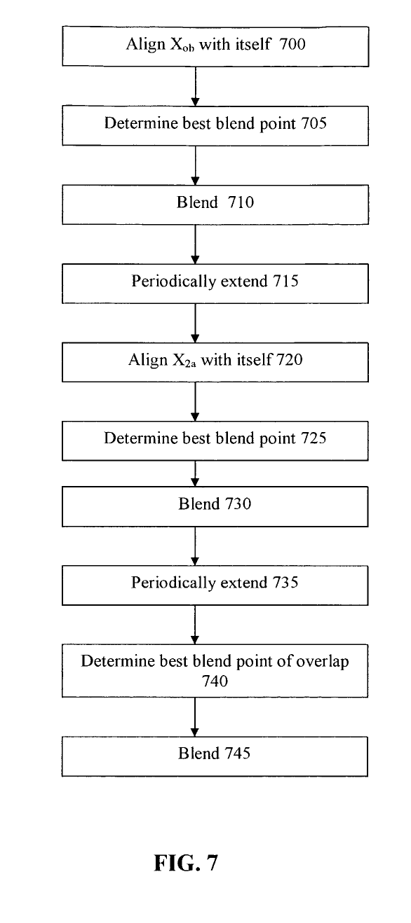

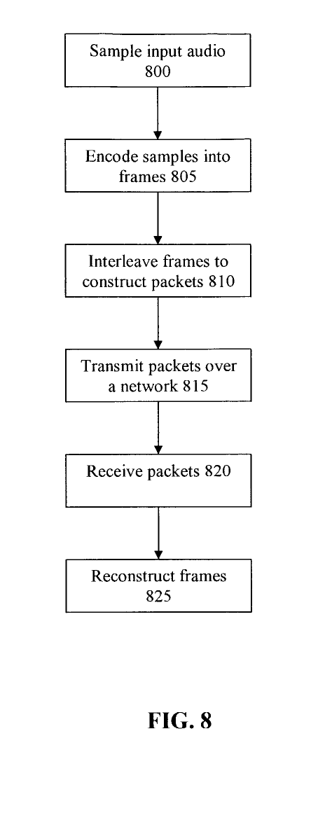

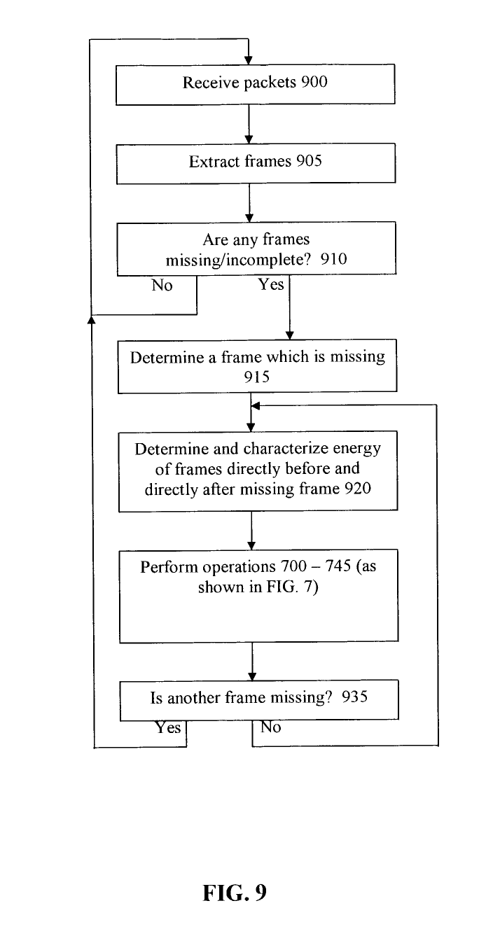

FIG. 7 illustrates a method to form reconstructed data according to an embodiment of the invention. Where the frame size is N samples, the gap size be K samples, and the size of the blending testing portion 615 is “L” samples, “w” is the window function containing blending factors applied within the blending testing portion 615 such that

w(i)=0.5+0.5 cos(π(2i−2L+1)/(2L)).

x₀ denotes the frame before the gap with samples x₀(0), . . . , x₀(N−1). N₀ denotes the number of samples to extend forward. X_{0b} denotes the last N₀ samples of x₀. x₁ denotes the gap with samples x₁(0), . . . ., x₁(K−1). x₂ denotes the frame after the gap with samples x₂(0), . . . , x₂(N-1). N₂ denotes the number of samples to extend backward. So denotes the number of samples to fill from the left. S₂ denotes the number of samples to fill from the right. The normalized cross-correlation between sequences x and y of length M is denoted as:

$$C ( x , y ) = \frac{{\sum }_{m = 0}^{M - 1} x ( m ) \cdot y ( m )}{{\sum }_{m = 0}^{M - 1} {x}^{2} ( m ) \cdot {\sum }_{m = 0}^{M - 1} {y}^{2} ( m )} .$$

The sum squared error between sequences x and y of length M is denoted as:

$$E ( x , y ) = {\sum }_{m = 0}^{M - 1} {[ x ( m ) - y ( m ) ]}^{2} .$$

The first operation of the method shown in FIG. 7 is to align 700 X_{0b} with itself, as shown below:

Let aᵢ=[x_{0b}(0) X_{0b} (1) . . . X_{0b}(N₀−L−1−i)].

Let bᵢ=[X_{0b}(L+i) X_{0b}(L+i+1) . . . X_{0b}(N₀−1)].

Then the best alignment of x₀ with itself is

$${m}_{0} = L + arg {max}_{i = 0 , ⋯ , {N}_{0} - L - 1} C ( {a}_{i} , {b}_{i} )$$

Next, the method determines 705 the best blend point within the overlapping part of X_{0b} and X_{0b} shifted by m₀:

Let aᵢ[x_{0b}(i)x_{0b}(i+1) . . . x_{0b}(i+L−1)].

Let bᵢ[X_{0b}(i+m₀)x_{0b}(i+m₀+1) . . . x_{0b}(i+M₀+L−1)].

The best blend point is

$${n}_{0} = arg {min}_{i = 0 , ⋯ , {N}_{0} - {m}_{0} - L - 1} E ( {a}_{i} , {b}_{i} )$$

Let y₀ be the length N-N₀+2m₀+n₀ sequence consisting of x₀, an L-sample blended region, and a final region from x_{0b}.

$${y}_{0} ( n ) = \{ \begin{matrix}{x}_{0} ( n ) , & n = 0 , ⋯ , N - {N}_{0} + {m}_{0} + {n}_{0} - 1 \\ {x}_{0} ( n ) \cdot w ( L - n + {n}_{0} ) + {x}_{0 b} ( n - N + {N}_{0} - {m}_{0} ) \cdot w ( n - {n}_{0} ) , & n = N - {N}_{0} + {m}_{0} + {n}_{0} , ⋯ , N - {N}_{0} + {m}_{0} + {n}_{0} + L - 1 \\ {x}_{0 b} ( n - N + {N}_{0} - {m}_{0} ) , & n = N - {N}_{0} + {m}_{0} + {n}_{0} + L , ⋯ , N - {N}_{0} + 2 {m}_{0} + {n}_{0} - 1\end{matrix}$$

Next, y₀ may be extended 715 periodically to the right if necessary. Operations 700-710 created a periodic component from x₀ which is the m₀-sample subsequence of y₀ denoted as:

Y₀ₚ=[y₀(N−N₀+m₀+n₀)y₀(N−N₀+m₀+n₀+1) . . . y₀(N−N₀+2m₀+n₀−1)]

Operation 715 extends y₀ to length N+S₀ by replicating and appending the periodic component.

Next, x₂ₐ is aligned 720 with itself. The best alignment m₂ may be determined in a way similar to that of operation 700, except in the left direction. The best blend point is then determined 725 within the overlapping part of x₂ₐ and x₂ₐ shifted by m₂. The best blend point may be determined in a way similar to that of operation 705, except in the left direction.

x₂ may then be blended 730 with itself to create y₂. The creation of y₂ may similar to the way y₀ was created in operation 710, except in the left direction. y₂ may then be extended 735 periodically to the left. As in operation 715, a m₂-sample segment of y₂ is replicated and appended to the beginning of y₂ to extend its length to N+S₂. Next, the best blend point is determined 740 between the overlapping parts of y₀ and y₂. The method described in operation 705 may be utilized to determine the best blend point in the overlapping region of y₀ and y₂. Finally, y₀ and y₂ may be blended together 745 to form a new sequence of length 2N+K. The blending may be accomplished according an operation similar to operation 710.

Note that if frame x2 is not available (e.g., it has not yet been received) it is still possible to achieve meaningful results by performing only operations 700-715 and extending fully to the right.

FIG. 8 illustrates a method to sample and encode frames into packet, transmit them across a network 145, and reconstruct them into an audio signal according to an embodiment of the invention. First, an input audio is sampled 800. The input audio may be received by a microphone in a cellular phone, or a microphone coupled to a computing device capable of supporting Internet Protocol telephony, for example. Next, the samples may be encoded 805 into frames by an encoding device such as a waveform encoder. The frames may then be interleaved 810 to construct packets of audio data. The packets may then be transmitted 815 over a network 145. Next, the transmitted packets may be received 820. The frames may be extracted, and the frames contained in any missing packets may be reconstructed 825.

FIG. 9 illustrates a method to reconstruct missing frames according to an embodiment of the invention. This method may be implemented by the frame reconstruction device 215. First, the packets having the interleaved frames are received 900. Next, the frames are extracted 905 from the received packets. The frame reconstruction device 215 may then determine 910 whether any frames are missing or incomplete. If “No,” the processing may continue back at operation 900. If “yes,” processing may proceed to operation 915. The frame reconstruction device 215 may then determine 915 a frame which is missing. Next, it may determine and characterize 920 the energy trajectory of frames directly before and directly after the missing frame. In an embodiment, only the first frame before and the first frame after a missing frame are utilized to determine what audio data to insert in place of the missing frame. In other embodiments, more than “1” frame before and/or more than “1” frame after the missing frame may be utilized. Next, operations 700-745 as discussed above with respect to FIG. 7 may be performed. Finally, the method may determine 935 whether another frame is missing. If “yes,” processing reverts to operation 900. If “no,” processing reverts to operation 920.

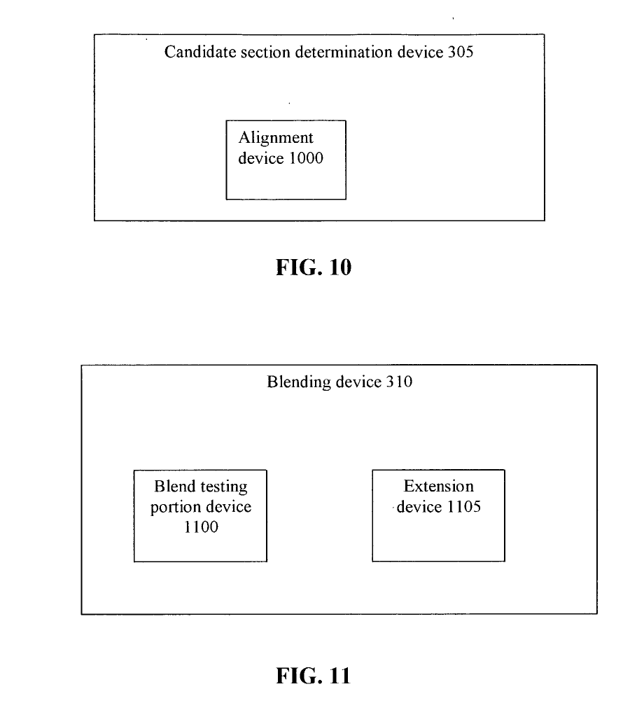

FIG. 10 illustrates an enlarged view of the candidate section determination device 305 according to an embodiment of the invention. As illustrated, the candidate section determination device 305 may include an alignment device 1000 to determine the best alignment point as described above with respect to FIGS. 6A-1 to 6A-3.

FIG. 11 illustrates an enlarged view of the blending device 310 according to an embodiment of the invention. As shown, the blending device 310 may include a blend testing portion device 1100 to determine an optimal blend sample point. The blending device 310 may also include an extension device 1105 to periodically extend a blended candidate selection piece.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A system, comprising:
a frame reception device to receive a stream of audio samples grouped into frames;
an energy determination device to determine a first energy trajectory of a first frame preceding a gap, and a second trajectory energy of a second frame, wherein the second frame is received after the first frame; and
a candidate testing and blending device to determine at least one of a first portion of the first frame and a second portion of the second frame to insert in place of the gap, based on the first energy trajectory and the second energy trajectory, and on a determination of an optimal blend point, and to blend with at least one of the first frame and the second frame.

2. The system of claim 1, further including a frame extraction device to extract the frames from packets.

3. The system of claim 1, wherein the candidate testing and blending device includes an alignment device to determine a best first alignment sample point between the first portion and a copy of the first portion.

4. The system of claim 1, wherein the candidate testing and blending device includes an alignment device to determine a best second alignment sample point between the second portion and a copy of the second portion.

5. The system of claim 1, wherein the candidate testing and blending device includes a blend testing portion device to determine a best first blend point between the first portion and a copy of the first portion.

6. The system of claim 1, wherein the candidate testing and blending device includes a blend testing portion device to determine a best second blend point between the first portion and a copy of the first portion.

7. The system of claim 1, wherein the candidate testing and blending device includes an extension device to periodically extend the at least one of the first portion and the second portion to fill the gap.

8. A method, comprising:
receiving a stream of audio samples grouped into frames;
determining a first energy trajectory of a first frame preceding a gap, and a second energy trajectory of a second frame, wherein the second frame is received after the first frame; and
determining at least one of a first portion of the first frame and a second portion of the second frame to insert in place of the gap, based on the first energy trajectory and the second energy trajectory, and based on a determination of an optimal blend point, blending with at least one of the first frame and the second frame.

9. The method of claim 8, further including extracting the frames from packets.

10. The method of claim 8, further including determining a best first alignment sample point between the first portion and a copy of the first portion.

11. The method of claim 10, wherein the best first alignment sample point is determined based on a cross-correlation measurement.

12. The method of claim 8, further including determining a best second alignment sample point between the second portion and a copy of the second portion.

13. The method of claim 12, wherein the best second alignment sample point is determined based on a cross-correlation measurement.

14. The method of claim 8, further including determining a best first blend point between the first portion and a copy of the first portion.

15. The method of claim 14, wherein the best first blend point is determined based on a minimization of a sum-squared error measurement.

16. The method of claim 8, further including determining a best second blend point between the first portion and a copy of the first portion.

17. The method of claim 16, wherein the best second blend point is determined based on a minimization of a sum-squared error measurement.

18. The method of claim 8, further including periodically extending the at least one of the first portion and the second portion to fill the gap.

19. An article comprising:
a storage medium having stored thereon first instructions that when executed by a machine result in the following:
receiving a stream of audio samples grouped into frames;
determining a first energy trajectory of a first frame preceding a gap, and a second energy trajectory of a second frame, wherein the second frame is received after the first frame; and
determining at least one of a first portion of the first frame and a second portion of the second frame to insert in place of the gap, based on the first energy trajectory and the second energy trajectory, and based on a determination of an optimal blend point, blending with at least one of the first frame and the second frame.

20. The article of claim 19, wherein the instructions further result in extracting the frames from packets.

21. The article of claim 19, wherein the instructions further result in determining a best first alignment sample point between the first portion and a copy of the first portion.

22. The article of claim 21, wherein the best first alignment sample point is determined based on a cross-correlation measurement.

23. The article of claim 19, wherein the instructions further result in determining a best second alignment sample point between the second portion and a copy of the second portion.

24. The article of claim 23, wherein the best second alignment sample point is determined based on a cross-correlation measurement.

25. The article of claim 19, wherein the instructions further result in determining a best first blend point between the first portion and a copy of the first portion.

26. The article of claim 25, wherein the best first blend point is determined based on a minimization of a sum-squared error measurement.

27. The article of claim 19, wherein the instructions further result in determining a best second blend point between the first portion and a copy of the first portion.

28. The article of claim 27, wherein the best second blend point is determined based on a minimization of a sum-squared error measurement.

29. The article of claim 19, wherein the instructions further result in periodically extending the at least one of the first portion and the second portion to fill the gap.
